(19) United States
(12) Patent Application Publication
(10) Pub. No.: US 2005/0208913 A1
(43) Pub. Date: Sep. 22, 2005

(54) Intelligent radio scanning

(76) Inventors: Vijay S. Raisinghani, Schaumburg, IL (US); Ramy P. Ayoub, Arlington Heights, IL (US); Sunil K. Joseph, Darien, IL (US)

Correspondence Address: MOTOROLA, INC., 1303 EAST ALGONQUIN ROAD, IL01/3RD, SCHAUMBURG, IL, 60196, US

(21) Appl. No.: 10/794,600

(22) Filed: Mar. 5, 2004

(51) Int. Cl. H04B 7/00

(52) U.S. Cl. 455/161.2; 455/3.02; 455/166.2

(57) ABSTRACT

The method and apparatus for selection of content on a device allows a radio to scan for desired (e.g. audio) selections being broadcast in accordance with a defined priority list that has been pre-stored. A found selection is played in order of priority and then placed back in the priority list in accordance with a prioritization logic. Desired content is identified by a digital signature or audio clip, for example. Associated with the identifier can be user interface settings, such as audio controls, and even vehicle settings such as window position, sun roof, moon roof, or convertible roof top, for example. The user interface can be used to store and sort identifiers and to provide control settings to the user in audio or video format.

### FIELD OF THE INVENTION

This invention generally relates to a radio interface, and more particularly, to an apparatus and method for scanning for particular content on a broadcast.

### BACKGROUND OF THE INVENTION

Radios in vehicles are receiving an increasingly diverse amount of content. Not only are amplitude modulation (AM) band frequency modulation (FM) band terrestrial radio broadcasts available along with television broadcasts, but there have been recent introductions of satellite broadcast services and internet services, all broadcast various content. Because the number of content channels can now be quite large, a user is at a disadvantage when trying to find particular desired content. Moreover, a driver of a vehicle cannot be distracted by manipulating tuning controls in a constant search for desired content.

One solution has been presented wherein a radio incorporates a search or scan control that finds and plays a few seconds of each station, in an AM or FM band, that has sufficient signal strength to be clearly heard and then wait for the user to select the heard channel. If the user does not select in a predetermined time, radio skips over to the next detected channel. However, this feature generally scans all radio stations, making the likelihood of finding acceptable content very small. In addition, this solution wastes much of a user's time listening to undesired content, and it still requires the manual intervention of the driver if desired content is found.

In addition, many users would like to adjust the listening environment for particular content. The only solution present today is a volume adjustment depending on a speed of a vehicle. However, this does not address particular content and is only applicable to audio volume.

Accordingly, there is a need for a system that will find desired content for a user without distraction to the user. It would also be of benefit if the listening environment could be automatically tailored to the particular desired content.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a block diagram of a system overview, in accordance with the present invention;

FIG. 2 shows a block diagram of a vehicle multimedia radio receiver with a display user interface, in accordance with the present invention;

FIG. 3 shows a front view of a vehicle multimedia radio receiver with alternate display interface;

FIG. 4 is a flow chart showing the steps for selection of audio content on a radio, in accordance with the present invention.

### DETAILED DESCRIPTION OF THE DRAWINGS

The present invention provides a method and apparatus that will find desired content for a user without distracting the user. In addition, the listening environment can be automatically tailored to the particular desired content. In particular, the present invention provides for selection of content on a multimedia device, such as a radio, by allowing the radio to scan for desired selections (e.g. audio content) being broadcast in accordance with a defined, pre-stored priority list. A found selection is played in order of priority and in accordance with user defined priority logic, such as being rotated to the bottom of the priority list after being played, for example. The priority management scheme can interrupt the currently playing content (e.g. stored audio clip, live radio, compact disc, etc.). The priority list can also take into account external factors such as time of day, day of the week, season of the year, etc. as inputs to decide on the selection to be played. Desired content is identified by an identifier, such as an analog or digital signature or audio clip, for example. In addition, user interface settings can be associated with the identifier and stored with reference to the associated identifier. The user interface settings can includes various audio controls, and even vehicle settings such as window position, sun roof, moon roof, or convertible roof top, for example. In addition, the user interface can be used to store and sort identifiers and to provide associated control settings in audio or video format.

The user interface can be used to build and store a user's desired priority list. The user interface can include a radio with a one or two line text display, or a separate video display. The user interface can accept voice, text or data inputs, through a microphone, keyboard, data port, and the like. Alternatively, the priority list can be remotely programmed through a wireless wide area network connection (e.g. cellular access), a wireless local area network connection or locally programmed through a wired connection with a computer for example. Preferably, data (including the identifier and associated attributes like controls position, volume level etc) could be transferred locally to the device using such local wireless technology as IrDA or Bluetooth, for example. Examples of data transfer devices include notebook computers, PDAs or cellular phones. Those skilled in the art will appreciate that other devices are contemplated without departing from the essential scope of the invention. A simple user interface may be built directly into the radio to allow the radio to select content to be stored into the radio, as well as provide a simple prioritization mechanism for the users.

The priority list can include an identifier for content, such as a digital signature used in the Radio Data System (RDS) or Digital Audio Broadcast (DAB) systems, for example. In addition, the identifier can be an analog or digital identifier that is modulated on the audio channel, such as is available in existing radio stations that FM modulate data or text identifying a song title for example. With an identifier present, the radio can scan desired channels to search for the identifier of content being broadcast to the radio just before, or during, playing of an associated song. In this way, the radio can switch to the channel playing the desired content before the content even begins playing. This provides a seamless transition without user interaction.

In practice, the priority list can include content text, such as a name of a song or of a generally desired artist, which would be provided by a broadcast station. With text, the radio can scan desired channels to search for text which is presented to the radio just before, or during, playing of an associated song. In this way, the radio can switch to the channel playing that desired song or artist. The priority list can include any other identifiers to perform the search. In addition, a user can add associated user-defined text, such as comments on that content, to any other identifiers in the priority list to assist the user in the management of the priority list.

Optionally, the radio, or processor therefor, can download a programming guide from a participating broadcast station to determine when a particular content will be played. Using this program guide, the radio can compare the program guide to the user's priority list to find desired content in the program guide and when the content will be broadcast by the broadcast station. The program guide can include text or other identifier which can be compared to corresponding text or identifier in the priority list. For example, the program guide can contain a list of names of songs to be played. Preferably, program listings (e.g., song play lists, etc.) are continuously updated throughout a day.

In any of the above embodiments, an identifier, such as text identifying a song, can be downloaded by the user through the user interface, or the user can press a defined button on the radio, when a desired song (or any desired audio information like news, chat shows, etc.) is being played, to store the identifier that identifies the desired content to the priority list. In addition, the user interface allows the user to set the priorities of each song stored in the list and to provide other list management options. Priority list management can be performed directly at the radio or by download to a portable user device for later remote sorting or management.

The priority list can also include audio clips as identifiers, such as a portion of a desired song. The audio clip can be downloaded by the user through the user interface, or the user can press a defined button on the radio, when a desired song is being played, to store a portion of that song to the priority list. The user can then assign associated text to the audio clip in the priority list for list management purposes. With audio clips, the radio can scan desired channels to search for corresponding audio being presented to the radio. This embodiment is less desirable inasmuch as there is a large amount of processing required and inasmuch as a desired song would have already started playing when the radio eventually switches to that song. To mitigate the delay problem, the radio in this embodiment can have a storage device that continuously stores, on a rotating basis, a previous amount of content which can be “rewound” when a particular desired audio clip is found. In this way, the radio can switch to the desired channel playing that song and replay the song from the beginning. The storage device can include a hard drive, flash disk or memory, USB flash, smart media, Compact flash, SD card, or any other storage media.

In all of the above embodiments, it is preferred that two receivers be utilized such that the scanning is done in the background while the user is listening to ordinary programming. In addition, processing power and time can be preserved by indicating on a select channel list only those desired channels that should be scanned. For example, if a user is interested in jazz music, the select channel list can further include an indication that only identified jazz radio stations should be scanned, and not classical radio stations for example.

Other content can be similarly scanned as described above. Such content can include personal information services (i.e. navigation, e-mail, news, stock reports, etc.). Moreover, channels can be scanned by the device for any informational updates or new software applications. For example, a user may wish to read e-mail as soon as this content is scanned from an internet access channel. Other content could be, for example, stock market alerts (i.e., set an alert when a stock reaches a set value), traffic alerts based upon the user's route (notifies of any delays as they happen in real time on the route), weather alerts, and the like.

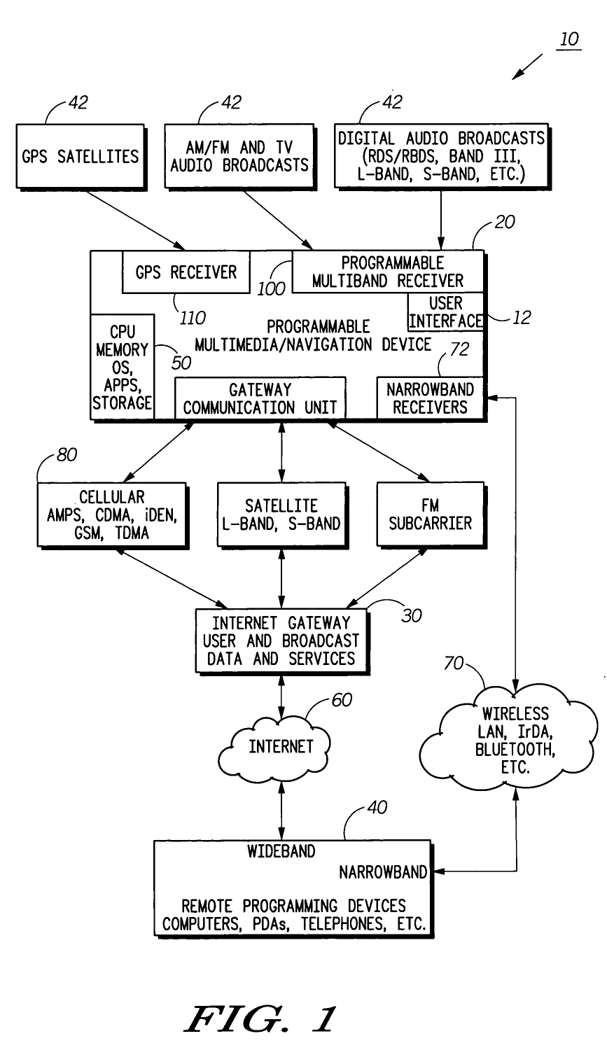

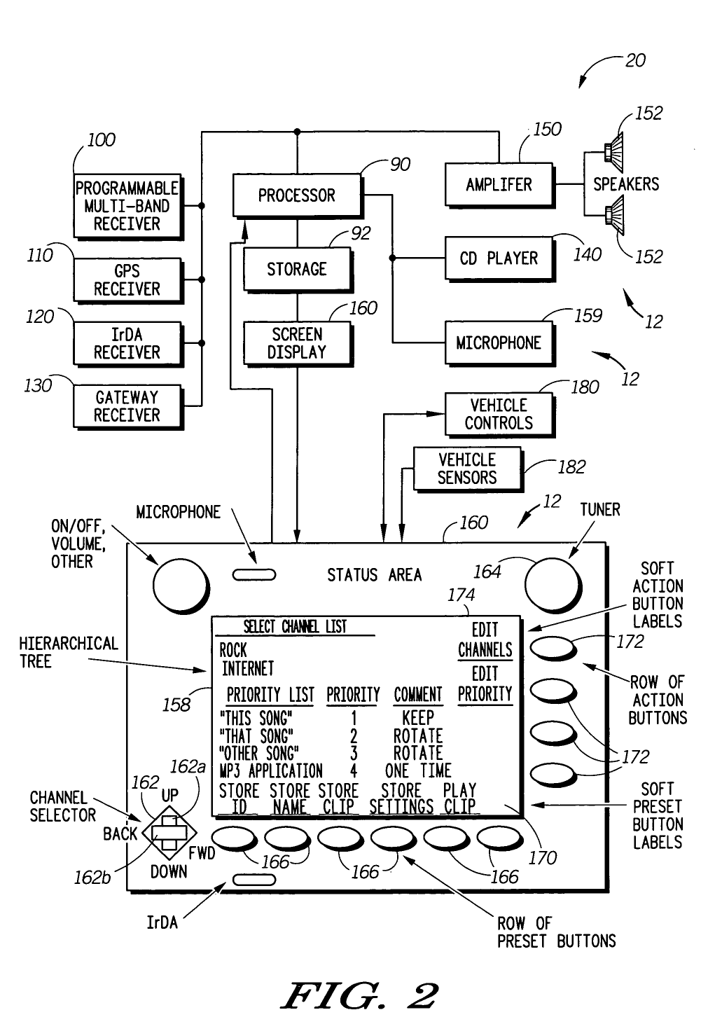

Referring to the drawings, where like elements receive like reference numerals throughout, the invention generally is a user interface for a radio, such as a radio in a vehicle for example, for enabling the selection of content on a multimedia device. As shown in FIGS. 1 and 2, the invention is operable with a programmable, microprocessor-controlled multimedia device 20 with a user interface 12 and broadcasters 42 that preferably provide identification data of content that can include one or more of an analog or digital identifier and text identifier. Optionally, separate programming devices 40 can be provided.

The multimedia device 20 includes a processor 50 that preferably runs an operating system and series of applications that control the operation of the device 20. A receiver 100 operates an application for tuning to a channel or scanning channels in keeping with the known radio paradigm and its user friendly operations. Preferably, the two types of content available are audio broadcasts (e.g., AM, FM, TV, digital, satellite, Internet audio broadcasts and recorded material) and personal information services (e.g., navigation, email, traffic alerts, etc.).

Desired channels can be organized in a Select Channel list on a user interface, such as a display screen (see FIG. 2). The actual organization of select channels can be configured by a user on the user interface or configured remotely by the user for downloading to the device, via the Internet gateway network 30 for example. Further, audio broadcast channels can be selected by the format of the broadcast (e.g., country, rock, talk, etc.) and not necessarily by the band or frequency of each station. For example, the select channel list may simply be “ROCK” and not necessarily list each rock station. The channels listed in the select channel list will limit any searching by the receiver 100 to only those listed channels. Personal information services can be similarly organized (e.g. news, sports, business, weather, etc.).

Desired content (e.g. songs) are organized in a priority list on a user interface, such as a display screen (see FIG. 2). The actual prioritization of desired content can be configured by a user on the user interface or configured remotely by the user for downloading to the device, via the Internet gateway network 30 for example. For example, the priority list can include song identifiers (e.g. Song A, Song B, etc.) with each song assigned a priority and any additional comments. The content listed in the priority list will be searched for by the receiver 100 in any of the channels from the selected channel list (if any).

Upon activation by a user, the selected audio and/or personal information services channels are scanned for the prioritized desired content as indicated on the pre-stored priority list. In the example shown, the user desires to scan for three particular songs and any MP3 software applications on the internet. For example, an internet gateway 30 can transmit software applications to the vehicle for use in the multimedia device 20. These applications are referred to as channels and are included in the personal information services of the system 10 (navigation, email, etc.). These applications or channels can be downloaded to the vehicle at any time to instantly add to the features of the multimedia device 20. For another example, a user may wish to read e-mail as soon as this content is scanned from an internet access channel. Other content could be, for example, stock market alerts (i.e., set an alert when a stock reaches a set value), traffic alerts based upon the user's route (notifies of any delays as they happen in real time on the route), weather alerts, and the like.

FIG. 1 shows many possible wireless communication methods between the vehicle device and broadcasters. As those skilled in the art will appreciate, the techniques illustrated in FIG. 1 are meant to be representative and do not reflect all possible wireless communication techniques that may be employed.

As FIGS. 1 and 2 show, the multimedia device 20 includes a processor and memory 90, and storage devices 92 that contain and run an operating system and applications to control and communicate with the onboard receivers. The receivers can include a multi-band AM, FM, TV audio and digital audio broadcast receiver 100; a global positioning system (GPS) receiver 110 that continuously reports the vehicle's longitude, latitude and altitude; one or more high-speed, narrow band wireless transceivers 120 for fast transmission and reception of large amounts of data from accommodated devices; and a wide band wireless gateway transceiver 130 that can receive one or more of Internet protocol-based audio broadcasts, new applications of information or data channels, and configuration data from a gateway network 30 created to service the multimedia devices 20. The multimedia device 20 also controls attached conventional multimedia storage equipment such as a CD/DVD player 140 or cassette player (not shown). Sound is output through an industry standard amplifier 150 and speakers 152 of the user interface 12. A microphone 159 of the user interface 12 allows for voice recognition commands to be given and received by the multimedia device 20 for programming the select channel list, priority list, and any other control features.

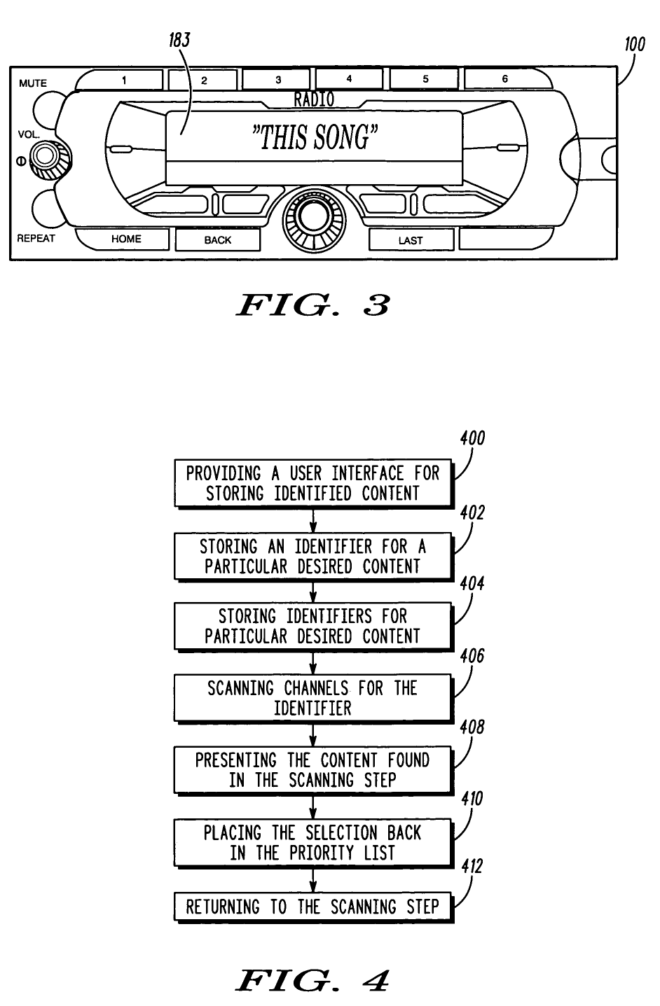

The multimedia device can have a user interface 12 with a LCD, LED or similar suitable display screen 160 for an automotive environment to present information to the user and to control the multimedia device 20. FIG. 2 shows a display screen 160, for example, Controls shown on the LCD in FIG. 2 are one possible embodiment for control types and location. Those skilled in the art will appreciate that control types and locations may vary in different implementations of the invention. In one presently preferred embodiment, for example, the display screen 160 includes a 5½ inch 640×480, 216 color VGA LCD display 168. In an alternate embodiment, the display can display as little as two lines of text on the radio itself (see FIG. 3), whereas the screen display 168 can have an upper limit of as large as the intended application may dictate.

The channel selector 162, tuner 164 and preset button 166 controls shown in FIG. 2 allow the user to broadly navigate all the channels of audio broadcasts and information services available on the multimedia device 20. In addition, channel selection can be entered in many other ways such as direct number entry through a keyboard (not shown). The channel selector 162 allows a user to manually access and select any of the audio and information channels available by browsing through them (up, down, forward, back) in the lists. A main display 158 is shown on the screen display 168 showing both the select channel and priority lists, for example. As is explained in detail below, the user can configure the lists for their personal preference.

Information for the lists can be pulled down from existing menus or can be entered manually or remotely by the user. Entries for the lists can then be stored for subsequent scanning. It should be recognized that there are many techniques known in the art for entering information into lists, and that any these various techniques will work equally well in the present invention.

Preset buttons 166, 172 on the display screen 160 are user configurable buttons that can be defined to allow the user to store identifiers of content to the priority list or to select channels. A computer application program running in the multimedia device 20 can control the defined buttons 166, 172 (shown in FIG. 2) to provide list management functions. A button label can indicate the button's current function. The defined button and its purpose may change from program to program.

Some examples of button labels 172 for programming could be: “EDIT CHANNELS” or “EDIT PRIORITY”, which would launch applications to either edit the select channel list or priority list. For example, the “EDIT PRIORITY” button could launch the application to modify the priority list, wherein a user could list selected content in hierarchal order such that if two songs are found the higher priority song will be played. This function could also have comments to manage the list. In the example shown, the comments direct how the entry is handled after being found and played. In particular, if “This Song” is found it will always take precedence over other entries in the priority list. However, if “That Song” or “Other Song” is found and played it is rotated to the bottom of the priority list, for example. Further, if an MP3 application is found and downloaded, as shown, this is executed only one time, and then dropped from the priority list. The comments can also be used for just that, commentary, and have no logic function associated therewith. In this case, each entry found and played would be rotated to the bottom of the list, continuously.

Other examples of the button label 166 could be: “STORE ID” to store an identifier (e.g. digital signature) of selected content currently being played; “STORE NAME” to store a name of selected content currently being played; “STORE CLIP” to store a clip of selected content currently being played; and “STORE SETTINGS” to store the audio and/or vehicle environment at the selected content is being played. For this last function, the vehicle and/or audio settings can be automatically stored with the identifier. For example, when listening to a desired song a user can adjust the audio volume and equalizer settings and then press the “STORE SETTINGS” button which stores not only the song identification on the priority list but also the associated audio and vehicle control settings. To make the system more efficient, the information of the selected channel (e.g. channel frequency, the time of day the selected song was played, etc.) can also be stored to assist in finding that song in the future.

Vehicle controls 180 can also be interfaced with the multimedia device 20 and display 160 using the “STORE SETTINGS” button. In particular, each identified content entry in the priority list can have vehicle controls associated therewith wherein the vehicle control are adjusted to a desired setting when the associated content is found and played. The simplest vehicle control envisioned is an audio volume control. For example, when a particular desired song in the priority list is found, an audio volume control setting associated with that song in the priority list will cause the volume to change to a designated setting or change in setting (e.g. increase the volume). Another vehicle control can be particular settings for a graphic equalizer for example, which is applied when a desired associated song is found and played. Another vehicle control is designating which speakers 152 are enabled for a particular content. For example, a news program could be played from only one speaker. This can be combined with other controls such as playing the news at a particular volume and/or equalizer setting. Another vehicle control is the operation of a communication device (e.g. Telematics unit, cellular phone, pager, etc.). For example, if desired content is being played the communication device can be turned off or the alert muted. Other vehicle controls envisioned in the present invention are the operation of windows or possible the operation of a convertible top. For example, the windows can go down when favorite song is found. Further, vehicle sensors 182 (e.g. outside temperature, vehicle speed, etc.) can be used to limit the operation of vehicle controls 180. Vehicle controls 180 can be combined with other controls such as playing the favorite song at a particular volume and/or equalizer setting (e.g. treble, bass, etc.).

A microphone input on the face of the display 160 allows users to control the multimedia device 20 verbally rather than through the control buttons. Key word recognition software allows the user to make the same channel or content selections that could be made from any of the button controls. Audio feedback through speech synthesis allows the user to make selections and hear if any other actions are required. Software or hardware based voice recognition and speech synthesis may be used to implement this feature.

FIG. 3 illustrates the radio 100 that can be used along with, or in lieu of a display (160 of FIG. 2). In this example, the radio has at least a one line text display 183 for use in displaying an identifier for content or a channel that is either being played or for the purposes of managing the select channel list or priority list. If no separate display is present then the function buttons 166, 172 can be represented by the radio buttons (e.g. 1-6).

Turning now to FIG. 4, a flow chart shows the operation for selecting content on a device, in accordance with the present invention. The method includes a step of storing 402 an identifier for a particular desired content. The identifier can include at least one of: an analog or digital signature of the particular desired content, text identifying the particular desired content, and a partial audio clip of the particular desired multimedia content. The identifier is stored in a priority list as previously explained.

A next step includes scanning 406 channels for the identifier. This can include scanning all available channels or selected channels. Preferably, desired channels for scanning are previously selected. More preferably, the scanning is done in the background while the user is listening to ordinary programming. This requires the use of a second receiver that can scan while a first receiver is playing selected content.

A next step includes presenting 408 the content found in the scanning step. Generally, this step includes providing audio signals to a vehicle audio environment. However, the content can be provided on a display, such as in a ticker tape fashion, if the content can be suitably presented thereon (e.g. stock report, weather report, etc.).

In general, the present invention is operable on a priority list that contains several items of desired content. As a result, the storing step includes storing a plurality of identifiers for particular desired content on a priority list. The identifier can be used to not only identify a particular song for example, but can also be used to just identify a desired artist. As a user may not wish to listen to the same content repeatedly, the present invention includes: placing 410 the selection back in the priority list according to a predetermined prioritization scheme; and then return 412 to scanning step 406 for the item at the top of the priority list. This returning step 412 also includes returning to the previous channel once the prioritized audio content has completed playing. In addition, the “return” channel can be user configurable.

It should be realized that there can be many possible prioritization schemes for working in the priority list and that the user may select the prioritization scheme of his or her choice. This can be menu driven. For example, there may be a linear prioritization scheme, a rotating prioritization scheme, a random prioritization scheme, etc.) If there is sufficient processing power, the radio can scan for all items on the priority list, not just the first item. If any item on the list is found, it is played and placed at the bottom of the list.

It is envisioned the user has complete control of the list and can direct and sort 402 the priority of items in the list in any fashion. For example, one item can have complete priority at all times and is not rotated, even interrupting another item playing on the list if found. In addition, an audio clip can be stored with a content identifier, wherein the user could recall and playback the audio clip to assist in sorting the priority list (shown as “PLAY CLIP” in FIG. 2). The user is given control of the priority list by providing 400 a user interface wherein the found content can not only be presented but also where identifiers can be identified for storage in a memory.

In a preferred embodiment the storing step includes storing a defined listening environment for each identifier, and wherein the presenting step includes changing the listening environment in accordance with the stored listening environment for the identifier of the content being presented. The listening environment can include audio volume, desired mode of presentation (e.g. audio, visual), which speakers are enabled, audio equalization, and vehicle controls such as communication device control and window settings, for example, as controlled by the user. For example, this feature can be enabled or disabled by the user from the user interface.

Also, before playing content found on the priority list, the radio can prompt the user for permission to play the desired content, by asking the user to depress a button, or utter a certain prompt through the voice recognition system (“Proceed”) before proceeding to play the desired content.

Additionally, if the user chooses to he or she can e-mail or transmit this selection of the channel to another user having a similarly capable system. For instance, if two people have a common love song, and if one of them finds this song being played he or she might like to share this song with his or her loved one. This can be accomplished by controls on the radio, local connected device or through voice recognition systems. This transmission of information could be via a wireless network (LAN, WAN, Bluetooth, WiFi, etc.) or using a Telematics server service or using e-mail. Dependent on the mechanism of delivery of this information, the recipient can automatically start playing the song or manually switch over to that radio channel.

Additionally, the radio shall provide a mechanism to synchronize this information with another radio of similar capability.

Additionally, the present invention gives a user the capability to record audio clips (and associated identifiers) which were heard in previously played songs, i.e., songs recorded first-in-first-out in an available storage device so that the user can select previously recorded material: “Save the last song”, “Save the song before the previous song” etc., according to device storage size limitations and system capabilities. Any selected material can have its identifier stored in the priority list. This can be accomplished by controls on the radio, local connected device or through voice recognition systems.

Additionally, the present invention can use an external input override that will essentially override the selection logic to force a particular channel to be selected. The use case for this would be, for example, a severe weather condition or a security alert in which case the user is forced to hear the new alert. This override could be a radio override, wherein a factory pre-stored audio clip or identifier is always scanned for on all channels and when detected overrides the user priority list. Optionally, the override could be another system input to the radio (e.g. audio, serial communication, etc.) which can force the radio to change the channel to an override channel.

While the present invention has been particularly shown and described with reference to particular embodiments thereof, it will be understood by those skilled in the art that various changes may be made and equivalents substituted for elements thereof without departing from the broad scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

1. A method of selection of content on a device, the method comprising the steps of:
storing an identifier for a particular desired content;
scanning broadcast channels for the identifier; and
presenting the content found in the scanning step.

2. The method of claim 1, wherein the identifier of the storing step includes a desired content source.

3. The method of claim 1, wherein the storing step includes storing a digital signature of the particular desired content.

4. The method of claim 1, wherein the storing step includes storing a partial audio clip of the particular desired content.

5. The method of claim 1, wherein the storing step includes storing a plurality of identifiers for particular desired content on a priority list, and further comprising the steps of:
placing the selection back in the priority list according to a predetermined prioritization scheme;
returning to the scanning step.

6. The method of claim 1, further comprising the step of sorting the plurality of identifiers for particular desired content on the priority list.

7. The method of claim 1, further comprising a step of providing a user interface wherein the found content can be presented and wherein identifiers can be identified for storage.

8. The method of claim 1, wherein the storing step includes storing a defined listening environment for each identifier, and wherein the presenting step includes changing the listening environment in accordance with the stored listening environment for the identifier of the content being presented.

9. The method of claim 1, further comprising the step of transmitting the identifier to another user having a similarly capable device.

10. The method of claim 9, further comprising the step of synchronizing the device to the similarly capable device.

11. The method of claim 1, further comprising the steps of:
recording content in a first-in-first-out basis in an available storage device;
selecting any past recorded content; and
storing an identifier for the selected past content.

12. The method of claim 1, further comprising the step of overriding the priority list with an external input override to force a particular channel to be selected.

13. A method of selection of audio content on a radio, the method comprising the steps of:
storing a priority list of digital signatures for associated particular desired audio content;
scanning available channels for the digital signatures in order of the priority list;
presenting any audio content found in the scanning step in order of the priority list;
placing the selection back in the priority list according to a predetermined prioritization scheme; and
returning to the scanning step.

14. The method of claim 13, further comprising the step of sorting the plurality of identifiers for particular desired content on the priority list.

15. The method of claim 13, further comprising a step of providing a user interface wherein the found content can be presented and wherein digital signatures can be stored.

16. The method of claim 13, wherein the storing step includes storing a defined listening environment for each digital signature, and wherein the presenting step includes changing the listening environment in accordance with the stored listening environment for the digital signature of the audio content being presented.

17. The method of claim 16, wherein the listening environment includes audio control settings for the radio.

18. The method of claim 16, wherein the listening environment includes which speakers are enabled in a vehicle.

19. The method of claim 16, wherein the listening environment includes vehicle control settings and external factors.

20. An apparatus for presenting content, the apparatus comprising:
a memory for storing an identifier for a particular desired content;
a processor for reading the memory;
a receiver that receives content, the receiver operable to scan available channels for the identifier under control of the processor;
a user interface for presenting the content found by the receiver.

21. The apparatus of claim 20, wherein the identifier includes at least one of the group of a digital signature of the particular desired content and a partial clip of the particular desired content.

22. The apparatus of claim 20, wherein the memory can store a plurality of identifiers for particular desired content in a priority list, and wherein the processor can place a selection found by the receiver back in the priority list according to a predetermined prioritization scheme.

23. The apparatus of claim 20, wherein the user interface and processor can be used to identify and sort the plurality of identifiers for particular desired content on the priority list in the memory.

24. The apparatus of claim 20, wherein the user interface and processor can be used storing a defined listening environment for each identifier in the memory, and wherein the processor can change the listening environment in accordance with the stored listening environment from the memory for the identifier of the content found by the receiver.

25. The apparatus of claim 24, wherein the apparatus is incorporated in a vehicle, and wherein the listening environment includes vehicle control settings and external factors, and wherein the processor is operable to control some of the vehicle control settings.
